(19) United States
(12) Patent Application Publication
(10) Pub. No.: US 2018/0195882 A1
(43) Pub. Date: Jul. 12, 2018

(54) OPTOELECTRONIC POSITION DETECTION SYSTEM AND METHOD OF POSITION DETERMINATION

(71) Applicant: SICK AG, Waldkirch (DE)

(72) Inventors: Thomas FEHRENBACH, Waldkirch (DE); Sebastian TSCHUCH, Waldkirch (DE); Martin FISCHER, Waldkirch (DE); Mathias AMS, Waldkirch (DE); Stefan SCHWÖRER, Waldkirch (DE)

(21) Appl. No.: 15/867,291

(22) Filed: Jan. 10, 2018

(30) Foreign Application Priority Data
Jan. 12, 2017 (DE) 10 2017 100 506.4

(51) Int. Cl. G01D 5/347

(52) U.S. Cl. CPC G01D 5/34715

(57) ABSTRACT

The invention relates to an optoelectronic position detection system for position determination having a positioning scale with position marks and a sensor apparatus with two sensor units each consisting of a light receiver for generating received signals from received light that was reflected by the position marks and each having an evaluation unit for evaluating the received signals and outputting the evaluation results. To provide a position detection system that works more robustly and more reliably and that in particular satisfies the functional safety such as is demanded by the relevant safety standards, it is proposed that the sensor units are configured as identical. The invention further relates to a method for failsafe position determination in which position marks on a positioning scale are detected by an optoelectronic position detection system.

The invention relates to an optoelectronic position detection system and to a method of position determination in accordance with the preamble of the respective independent claim.

Known optoelectronic positioning systems consist of a code-reading sensor and a position scale that has a plurality of optical position marks, for instance barcodes or similar special markings, in a row. The position marks include a piece of absolute information on their own positions within the position scale or with respect to a different reference. The sensor is able to detect a position mark and to read its position information. If the sensor is in a relative movement to the position scale, the sensor can draw a conclusion on its own position with reference to the position information read out. An important application is to fix the sensor to a vehicle and to attach the position marks along a provided travel distance, for example along a rail. Typical applications are suspension conveyors or suspension tracks. The vehicle can be automatically steered directly to specific positions or can orient itself using the positioning system.

Since such automatically traveling vehicles also always represent an accident risk if, for example, they have incorrect position information, positioning systems are known that comprise special measures to make the position determination safer.

Such an apparatus for safe position determination is known, for example, from DE 102005047658 B4. Safety is increased in that the position marks are detected by two different (diverse) sensors and their results are output by means of a failsafe “output circuit” as safe output signals that are in turn processed in a safe PCL.

It is disadvantageous here that two different sensor types have to be used, which is complex and expensive. Different sensor systems mean a series of disadvantages for the user such as more know-how for configuration and settings among maintenance and service personnel, more complex and/or expensive storage (different holders, connector cables, etc.), different software required for the sensor configuration, different contact partners in product support, worse conditions for framework contracts with two sensor manufacturers instead of one. It is further disadvantageous that the two sensors in the system in accordance with DE 102005047658 B4 read the same barcodes simultaneously since reading problems then occur in the event of dirt on the barcodes. Such dirt can be expected in a number of applications in real operation, particularly at rail joints, points, screw positions, and the like, but also simply due to longer wear.

It is therefore the object of the invention to provide a position detection system of the category that works more robustly and reliably and can in particular satisfy the functional safety such as is demanded by the standards (EN 61508, EN 62061, EN ISO 13849) without greater effort and/or expense.

This object is satisfied by an optoelectronic position detection system and by a method of position determination in accordance with the respective independent claim.

The optoelectronic position system for position determination comprises a positioning scale having position marks, a sensor apparatus having two sensor units each comprising a light receiver for generating received signals from received light that was reflected by the position marks and each having an evaluation unit for evaluating the received signals and outputting the evaluation results. In accordance with the invention, the sensor units are configured as identical and are arranged in a fixed spatial relationship and at a spacing from one another such that a first one of the two sensor units always detects at least two position marks and the second one of the sensor units always detects three different position marks. The evaluation results provided by the evaluation units are supplied to a safety control in which a piece of failsafe information is generated from the evaluation results.

The invention has the advantage that two identical sensor units are used. The initially named disadvantages such as more know-how for configuration and settings among maintenance and servicing personnel, more complex and/or expensive storage, different software for the sensor configuration, increased product support, etc. are avoided.

The diversity required to satisfy the standards is actually lost with identical sensor units; however, a central idea of the invention comes into play here since a quasi-diversity is provided by the further characterizing features of the invention, namely the arrangement of the sensor units in a fixed spatial relationship and at a spacing from one another such that a first one of the two sensor units always detects at least two position marks and the second one of the sensor unit always detects three different position marks. For with such an arrangement, the raw data of the sensors are diverse, and indeed in a variety of manners. First, different codes are read; second, different numbers of codes are read; third, all the codes are read twice at different points in time, namely once by the first sensor unit and then, on a continued travel, also by the second sensor unit. A quasi-diversity is obtained by this plurality of measures that is equivalent to or at least so close to the true diversity of the two diverse sensors that the safety standards can be satisfied.

Finally, for a common, failsafe result of the position measurement of the optoelectronic position detection system in accordance with the invention, the two evaluation results provided by the evaluation units have to be supplied to a safety control in which a piece of failsafe information is generated from the evaluation results.

Furthermore, reading errors due to dirt or the like can be managed better since a plurality of codes are read twice at different points in time.

If the sensors are tilted with respect to one another such that the position marks can be seen at different angles of view by the sensor units, the “degree of diversity” can thereby be increased, i.e. the diversity in the sense of the standards is improved or amplified.

It is advantageous for a fixed and long-term spatial association for the sensor units to be installed on a common holder.

It is possible due to the fixed spatial association to check the evaluation results of the two sensor units for plausibility in the safety control, that is e.g. to check whether the offset of the sensor unit is reflected in the position values that correspond to the evaluation results. Or expressed in simpler terms, whether the difference of the position results of the individual sensor units corresponds to the spacing of the sensor units. Such a check further increases the safety.

The safety control compares positions determined by the first sensor unit and by the second sensor unit with one another or applies them against one another to form a common position. The comparison serves, for example, to reveal a defect in safe applications. The application against one another produces a higher measurement accuracy due to a data fusion of two independent measured values.

This is also a subject of the method claim.

The invention will also be explained in the following with respect to further advantages and features with reference to the enclosed drawing and to embodiments. The FIGURE of the drawing shows in:

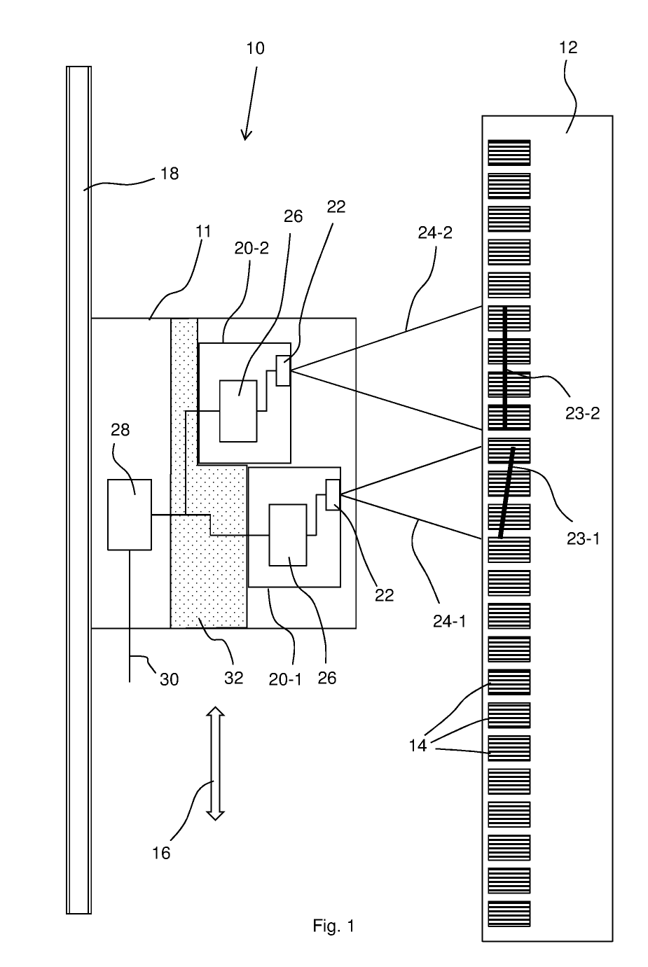

FIG. 1 a schematic representation of an optoelectronic position detection system for determining the position using a scale having position marks.

FIG. 1 shows a schematic representation of an optoelectronic position detection system 10 that recognizes the position of a sensor apparatus 11 along a travel path using a scale 12 having position marks 14. In operation, the sensor apparatus 11 is in a relative movement with respect to the scale 12; for example, because the sensor apparatus 11 is fastened to a vehicle and the scale 12 is fastened to a wall or on the ground along the provided travel distance. The movement (direction 16) of the sensor apparatus 11 or of the vehicle is frequently guided linearly in a compulsory manner, for example by rails 18. The scale 12 can then be attached at defined intervals along the compulsory guide.

The sensor apparatus 11 has two identically configured sensor units 20-1 and 20-2. Each of the sensor units has a light receiver 22 for generating received signals from received light. Different embodiments are possible. The light receiver 22 can be an image sensor, for example a pixel-resolved matrix arrangement or linear arrangement of light reception elements in CCD or CMOS technology. It is, however, also possible, for example, that the sensor unit 20 is a scanner that transmits a reading beam via a rotating mirror or via a polygon wheel mirror and receives it again and thus scans the respective section of the scale 12. Such a laser beam is marked by 23-1 and 23-2 in FIG. 1. The light/dark signal of the scanning beam also delivers a line of pixels per scan after an A/D conversion, said pixels equally being understood as image data like the records of an image sensor.

Each sensor unit 20-1 or 20-2 has a respective field of vision 24-1 and 24-2 respectively for the optical detection of the position marks 14 located in the field of vision. The sensor units 20-1 and 20-2 are in this respect arranged in the sensor apparatus 11 and the sensor apparatus 11 and the scale 12 are arranged with respect to one another such that the first sensor unit 20-1 always detects at least two of the position marks 14 and the second sensor unit 20-2 always detects three different position marks 14.

Irrespective of their specific acquisition, the image data are transferred from the light receiver 22 to an evaluation unit 26. The position information contained in the position marks 14 is decoded in a manner known per se from the image data in the evaluation unit. The position marks 14, for example, include a piece of metric position information or a piece of spacing information with respect to a reference, preferably in an absolute coding. In an incremental coding, that is also conceivable, the sensor apparatus 11 can only determine its position relative to a starting signal or an initial reference travel is necessary.

The position information provided by the evaluation units 26 is supplied to a safety control 28 in which a piece of failsafe information is generated from the two different pieces of position information. Depending on this failsafe position information, a holding signal, an emergency stop signal or the like or the failsafe position information itself can be output at an output 30.

The sensor apparatus 11 derives its own position from the position information with the aid of known parameters or parameters taught in advance such as perspective and the spacing from the scale 12. This conversion can be avoided if the position marks 14 already contain position information related to the sensor apparatus 11 in coded form. The conversion is anyway omitted on an orientation of the sensor 10 perpendicular to the scale 12 and on a position determination in only one dimension. A speed of the relative movement between the sensor apparatus 11 and the scale 12 can also be estimated from at least two position determinations and the associated points in time.

The sensor units 20-1 and 20-2 are arranged in a fixed spatial relationship and at a spacing from one another in the direction of movement 16. So that this arrangement is fixed and defined, the sensor units 20-1 and 20-3 are installed on a common holder 32. The holder 32 can be a solid installation block that is fixed in a housing of the sensor apparatus 11, with the installation block being able to have abutments for a defined fixing of the sensor units 20-1 and 20-2.

The sensor units 20-1 and 20-2 can furthermore be tilted with respect to one another such as should be made clear by the non-parallelism of the reading lines 23-1 and 23-2 shown in FIG. 1. The position marks 14 are in this manner seen at different angles of view by the sensor units 20-1 and 20-2.

The method in accordance with the invention for the failsafe position determination comprises the following steps: First, the position marks 14 on a positioning scale 12 are optically detected by the sensor apparatus. In the evaluation units 26 of the sensor units 20-1 and 20-2, the position information coded in the position marks 14 is decoded and this position information is forwarded to the safety control 28. A check is made in the safety control 28 whether the difference of the two pieces of position information is plausible with respect to the spatial spacing of the two sensor units 20-1 and 20-2. If the plausibility is given, a piece of failsafe information is acquired for the sensor apparatus from the two pieces of position information. This failsafe information is output or otherwise processed as required. For example, the failsafe position information could be used to generate a safety signal independently thereof.

1. An optoelectronic position detection system for position determination, the optoelectronic position detection system comprising:
a positioning scale with position marks; and
a sensor apparatus with two sensor units each consisting of a light receiver for generating received signals from received light that was reflected by the position marks and each having an evaluation unit for evaluating the received signals and outputting the evaluation results, wherein the sensor units are configured as identical; and wherein the sensor units are arranged in a fixed spatial relationship and at a spacing from one another such that a first one of the two sensor units always detects at least two position marks and the second one of the sensor units always detects three different position marks; and wherein the evaluation results are supplied to a safety control in which a piece of failsafe position information is generated from the evaluation results.

2. The system in accordance with claim 1, wherein the sensor units are tilted with respect to one another such that the position marks are seen at different angles of view by the sensor units.

3. The system in accordance with claim 1, wherein the sensor units are installed on a common holder.

4. The system in accordance with claim 1, wherein the evaluation results are position results; and wherein the control unit checks the two positions determined for plausibility.

5. A method for failsafe position determination in which position marks on a positioning scale are detected by an optoelectronic position detection system comprising:
a positioning scale with position marks; and
a sensor apparatus with two sensor units each consisting of a light receiver for generating received signals from received light that was reflected by the position marks and each having an evaluation unit for evaluating the received signals and outputting the evaluation results, wherein the sensor units are configured as identical; and wherein the sensor units are arranged in a fixed spatial relationship and at a spacing from one another such that a first one of the two sensor units always detects at least two position marks and the second one of the sensor units always detects three different position marks; and wherein the evaluation results are supplied to a safety control in which a piece of failsafe position information is generated from the evaluation results, and in which method position information coded in the position marks is read out and the position information with respect to a failsafe position indication is processed in the safety control, with the safety control checking whether the position information with respect to the spatial spacing of the sensor units is plausible.
